(19) United States
(12) Patent Application Publication
(10) Pub. No.: US 2021/0003420 A1
(43) Pub. Date: Jan. 7, 2021

(54) Maintaining and Generating Digital Road Maps

(71) Applicant: Continental Automotive GmbH, Hannover (DE)

(72) Inventor: Helmut Hamperl, München (DE)

(73) Assignee: Continental Automotive GmbH, Hannover (DE)

(21) Appl. No.: 16/982,884

(22) PCT Filed: Mar. 21, 2019
(86) PCT No.: PCT/EP2019/057090

§ 371 Date: Sep. 21, 2020

(30) Foreign Application Priority Data
Mar. 23, 2018 (DE) 10 2018 204 501.1

(51) Int. Cl. G01C 21/00; G06T 7/70; G06T 7/11; G06K 9/62; G06K 9/00

(52) U.S. Cl. CPC G01C 21/3859; G01C 21/3815; G01C 21/3841; G06T 7/70; G06T 2207/20021; G06K 9/6267; G06K 9/00791; G06T 2207/30252; G06T 7/11

(57) ABSTRACT

An object confidence value generation system for a digital road map comprising: a backend and an object recognition device for a vehicle including: a capture unit, an evaluation unit, a positioning unit, and a transceiver. The capture unit captures and divides the surroundings data into segments. The positioning unit determines positions of the segments and of any objects therein. The evaluation unit recognizes the objects and concealed objects associates them with position information. The evaluation unit determines a probability of correct recognition for each object. The probability depends on the relative position of the segment with respect to the object recognition device. The backend generates or updates the digital road map based on the data. Each of the objects in the digital road map has an associated confidence value. The backend adjusts the confidence value of the object based on the determined probability.

### CROSS-REFERENCE TO RELATED APPLICATIONS

This application is a U.S. National Stage Application of International Application No. PCT/EP2019/057090 filed Mar. 21, 2019, which designates the United States of America, and claims priority to DE Application No. 10 2018 204 501.1 filed Mar. 23, 2018, the contents of which are hereby incorporated by reference in their entirety.

### TECHNICAL FIELD

The present disclosure relates to maps. Various embodiments include object confidence value generation systems for generating confidence values for objects in a digital road map, vehicles having an object recognition device, backends containing a digital road map, methods for generating confidence values for objects in a digital road map, program elements, and/or computer-readable media.

### BACKGROUND

Vehicles are increasingly provided with driver assistance systems that assist the driver in performing driving maneuvers. Furthermore, vehicles are increasingly equipped with highly or fully automatic driving functions. Highly precise digital road maps are required for these highly or fully automatic driving functions to ensure safe and reliable navigation of the vehicles and to recognize objects such as traffic signs or road markings.

Furthermore, these digital road maps must always have the current status of the roads and traffic signs in order to enable the highly or fully automatic driving functions. Furthermore, modern vehicles have a large number of sensors for capturing the vehicle surroundings.

### SUMMARY

Various embodiments of the teachings of the present disclosure include methods and systems to update, to change, or to create a digital road map. For example, some embodiments include an object confidence value generation system for generating confidence values for objects (31) in a digital road map (3), having: a backend (2); and an object recognition device (1) for a vehicle (4), the object recognition device (1) having: a capture unit (13); an evaluation unit (10); a positioning unit (11); and a transceiver unit (12), wherein the capture unit (13) is configured to capture surroundings data from a vehicle (4) and to divide the surroundings data into a plurality of two-dimensional or three-dimensional segments, wherein the positioning unit (11) is configured to determine the positions of the segments and of the objects (31) contained therein, wherein the evaluation unit (10) is configured to recognize the objects (31) and concealments (21) of the objects (31) in the segments and to provide them with position information, wherein the evaluation unit (10) is also configured to determine a probability of correct recognition for each of the objects (31) and for each concealment (21), wherein the probability depends on the relative position of the segment, in which the object (31) or the concealment (21) is located, with respect to the object recognition device (1), wherein the transceiver unit (12) is configured to transmit the data generated by the evaluation unit (10) to the backend (2), wherein the backend (2) is configured to receive the data from the transceiver unit (12) and to generate or to update the digital road map (3), wherein each of the objects (31) in the digital road map (3) in the backend (2) has a confidence value; wherein the backend (2) is configured to increase the confidence value of the respective object (31) on the basis of the determined probability if the respective object (31) is included in the received data, and wherein the backend (2) is configured to reduce the confidence value of the respective object (31) on the basis of the determined probability if the respective object (31) is not included in the received data, wherein the backend (2) is configured not to reduce the confidence value of the respective object (31) in the event of a concealment (21) of the object (31) in the received data.

In some embodiments, the evaluation unit (10) is configured to determine the probability of the correct recognition of the objects (31) or the concealments (21) of the objects (31) on the basis of the distance and the angle of the recognized objects (31) with respect to the object recognition device (1) in the respective segment, wherein a greater distance between the respective segment and the object recognition device (1) results in a lower probability of correct recognition and a shorter distance between the respective segment and the object recognition device (1) results in a higher probability of correct recognition.

In some embodiments, the backend (2) incorporates an object (31) or a concealment (21) of an object (31) for the determination of the confidence value only when the probability of correct recognition is above a predetermined threshold value.

In some embodiments, the evaluation unit (10) is configured to evaluate the surroundings data relating to a section (5) of a route covered by the vehicle (4), and wherein the transceiver unit (12) is configured to send the data relating to the entire section (5) to the backend (2).

In some embodiments, the section (5) is 100 m long.

In some embodiments, the evaluation unit (10) is configured to initially classify all captured segments in front of the vehicle (4) in the respective section as concealed regions and, if an object (31) has been recognized in a segment or a concealment (21) is not recognized in the segment, to classify the corresponding segment as a visible region and to determine the probability of correct recognition, wherein the backend (2) is configured not to incorporate the concealed segments into the determination of the confidence values of the individual objects (31) in the digital road map (3).

In some embodiments, the object recognition device furthermore comprises a storage unit (14), wherein a digital road map (3) containing a multiplicity of objects (31) is stored in the storage unit (14), wherein the evaluation unit (10) is configured to compare the recognized objects (31) with the objects (31) stored in the storage unit (14), wherein the evaluation unit (10) is furthermore configured to report recognized objects (31) that are not present in the digital road map (3) in the storage unit (14), or unrecognized objects that should be recognized according to the digital road map (3), to the backend (2).

In some embodiments, the backend (2) is configured to transmit the digital road map (3) to the storage unit (14) of the object recognition device (1) at periodic time intervals.

In some embodiments, the backend (2) is configured to transmit only objects (31) having a confidence value above a predefined threshold value to the storage unit (14) of the object recognition device (1).

In some embodiments, the backend (2) is configured to evaluate the received data and to remove unrecognized objects from or to integrate new objects in the digital road map (3) in the backend (2) on the basis of the received data.

As another example, some embodiments include a vehicle (4) having an object recognition device (1), the object recognition device (1) having: a capture unit (13); an evaluation unit (10); a positioning unit (11); and a transceiver unit (12), wherein the capture unit (13) is configured to capture surroundings data from a vehicle (4) and to divide the surroundings data into a plurality of two-dimensional or three-dimensional segments, wherein the positioning unit (11) is configured to determine the positions of the segments and of the objects (31) contained therein, wherein the evaluation unit (10) is configured to recognize the objects (31) and concealments (21) of the objects (31) in the segments and to provide them with position information, wherein the evaluation unit (10) is also configured to determine a probability of correct recognition for each of the objects (31) and for each concealment (21), wherein the probability depends on the relative position of the segment, in which the object (31) or the concealment (21) is located, with respect to the vehicle, wherein the transceiver unit (12) is configured to transmit the data generated by the evaluation unit (10) to a backend (2).

As another example, some embodiments include a backend (2) containing a digital road map (3) and confidence values for the objects (31) therein, wherein the backend (2) is configured to receive the data from a transceiver unit (12) and to generate or to update the digital road map (3), wherein each of the objects (31) in the digital road map (3) in the backend (2) has a confidence value; wherein the backend (2) is configured to increase the confidence value of the respective object (31) on the basis of the determined probability if the respective object (31) is included in the received data, and wherein the backend (2) is configured to reduce the confidence value of the respective object (31) on the basis of the determined probability if the respective object (31) is not included in the received data, wherein the backend (2) is configured not to reduce the confidence value of the respective object (31) in the event of a concealment (21) of the object (31) in the received data.

As another example, some embodiments include a method for generating confidence values for objects in a digital road map, having the following steps: capturing (S1) surroundings data and dividing said data into a plurality of two-dimensional or three-dimensional segments by means of a capture unit; determining (S2) the position of the segments and the objects contained therein; evaluating (S3) the captured surroundings data in each of the segments; recognizing (S4) objects and concealments of objects in each of the segments; determining (S5) a probability of correct recognition for each object or each concealment, wherein the probability depends on the relative position of the segment, in which the object or the concealment is located, with respect to the vehicle; providing (S6) the objects and the concealments of the objects with position information; transmitting (S7) the generated data from a transceiver unit to a backend; generating (S8) or updating the digital road map in the backend based on the received data; increasing (S9) the confidence value of the respective object on the basis of the determined probability of correct recognition if the respective object is included in the received data; reducing (S10) the confidence value of the respective object on the basis of the determined probability of correct recognition if the respective object is not included in the received data, wherein the respective object is not reduced in the event of a concealment of the object in the received data.

As another example, some embodiments include program elements that, when they are on an evaluation unit and a backend of an object confidence value generation system, prompt the evaluation unit and the backend to perform the methods described herein.

As another example, some embodiments include computer-readable media on which one or more of the program elements as described herein are stored.

### BRIEF DESCRIPTION OF THE DRAWINGS

Further features, advantages, and possible applications of the teachings herein emerge from the description of the exemplary embodiments and the figures that follows. The figures are schematic and not to scale. If the same reference signs are specified in the description of the figures that follows, they denote identical or similar elements.

FIG. 1 shows a block diagram of an object confidence value generation system incorporating teachings of the present disclosure;

FIG. 2 shows a schematic illustration of surroundings data containing a recognized object incorporating teachings of the present disclosure;

FIG. 3 shows a schematic illustration of surroundings data containing a concealment incorporating teachings of the present disclosure;

FIG. 4 shows a division of the field of view of the capture unit into cuboids incorporating teachings of the present disclosure;

FIG. 5 shows a division of the field of view of the capture unit by means of cylindrical coordinates incorporating teachings of the present disclosure;

FIG. 6 shows a schematic illustration of a vehicle trajectory with evaluation of the surroundings data in sections incorporating teachings of the present disclosure;

FIG. 7 shows a vehicle having an object recognition device incorporating teachings of the present disclosure;

FIG. 8 shows a flowchart for a method for generating confidence values for objects in a digital map in the backend incorporating teachings of the present disclosure.

### DETAILED DESCRIPTION

Various embodiments of the teachings herein include an object confidence value generation system for generating confidence values for objects in a digital road map. The object confidence value generation system has a backend and an object recognition device for a vehicle. The object recognition device in turn has a capture unit, an evaluation unit, a positioning unit and a transceiver unit. The capture unit is configured to capture surroundings data from a vehicle and to divide the surroundings data into a plurality of two-dimensional or three-dimensional segments. The positioning unit is configured to determine the positions of the segments and of the objects contained therein. The evaluation unit is configured to recognize the objects and concealments of the objects in the segments and to provide them with position information. The evaluation unit is also configured to determine a probability of correct recognition for each of the objects and for each concealment, wherein the probability depends on the relative position of the segment, in which the object or the concealment is located, with respect to the object recognition device or the vehicle. The transceiver unit is configured to transmit the data generated by the evaluation unit to the backend.

The backend is configured to receive the data from the transceiver unit and to generate, to change or to update the digital road map. Furthermore, each of the objects in the digital road map in the backend has a confidence value. The backend is configured to increase the confidence value of the respective object on the basis of the determined probability if the respective object is included in the received data, and to reduce the confidence value of the respective object on the basis of the determined probability if the respective object is not included in the received data, wherein the backend is configured to not reduce the confidence value of the respective object if the object is concealed in the received data.

In order to improve the quality of digital road maps, these may be continuously updated, changed or generated on the basis of data collected or generated by the vehicles themselves. To this end, a digital road map may be present on a backend and a plurality of object recognition devices, for example in vehicles, may be used as sensors on the road. Traffic guidance (the route) and objects such as traffic signs may in particular thus be updated, changed or generated in the digital road map. For this purpose, each of the objects in the digital road map may have an individual confidence value that indicates the reliability of the information, for example the existence, the position or the content, about this object.

This confidence value may be changed by the backend based on data from the object recognition device or a multiplicity of object recognition devices. The confidence value may for example be between 0 and 1, with 1 indicating maximum reliability of the information about the respective object and 0 indicating minimum reliability of this information. The underlying idea in this case may be that a multiplicity of object recognition devices recognize or do not recognize an object (because it is no longer present). It is thereby possible on average to exclude, eliminate or reduce individual errors in the recognition by individual object recognition devices.

As a result, the confidence value of the object is gradually adjusted and changes to the objects in road traffic may thus be captured automatically and continuously by the backend, such that an up-to-date representation of reality is always able to be shown in the digital road map on the backend. If the confidence value of a new object (not previously present in the digital road map) exceeds a predefined threshold value, it may be assumed that this object is also present in reality and it may be added to the digital road map on the backend. If on the other hand the confidence value of an object falls below a predefined threshold value, it may be assumed that this object is no longer present in reality and it may thus be removed from the digital road map in the backend.

Furthermore, the capture unit, for example a camera, a stereo camera, a radar sensor, a lidar sensor, an ultrasonic sensor, a laser scanner or a combination thereof, can divide the captured surroundings data into a plurality of two-dimensional or three-dimensional segments. The segmentation and the respective position of the segment can be used to determine a probability of the correct recognition of the object or the concealment. In particular, the relative position of the segment of the respective object or of the concealment with respect to the object recognition device or the vehicle can influence the probability of correct recognition.

The greater the distance between the object and the object recognition device or the vehicle and the further an object is in an edge region of the surroundings data from the capture unit, the lower the probability may be of the object or the concealment having been correctly recognized. The probability of correct recognition may also be higher if the object or the concealment is at a short distance centrally in front of the capture unit. In other words, a probability of correct recognition by the object recognition device can be determined with the aid of the plurality of two-dimensional or three-dimensional segments and the relative position of these segments with respect to the object recognition device. The probability of correct recognition can be determined for the respective segments, wherein the probability of correct recognition can depend on the position of the segment in the field of view (capture region) of the capture unit. The probability of correct recognition for the recognized objects or concealments can be determined by the segment in which the object or the concealment is located.

In some embodiments, the segments are constant cuboidal volumes having a width, a height and a depth which are constant over time. In other words, the division into segments can be carried out on the basis of Cartesian coordinates. It should be noted that the segments may be cuboids or cubes.

In some embodiments, the segments are sectors of a circle which are pierced by a plurality of radii and which have an angle, a height and a starting radius and an end radius. In other words, the segments can be divided on the basis of cylindrical coordinates. In some embodiments, it is also possible to divide the segments on the basis of spherical coordinates. Furthermore, a camera image can be divided into two-dimensional segments and the depth information is provided via a further sensor, for example a lidar sensor.

The backend can increase the confidence value of an object on the basis of the determined probability of correct recognition of this object if the object has been recognized by the object recognition device and is included in the data transmitted to the backend. Furthermore, the backend can reduce the confidence value of an object on the basis of the determined probability of correct recognition of this object if the latter has not been recognized by the object recognition device or is not included in the data transmitted to the backend. The backend may furthermore not change or adjust the confidence value of the object in the digital road map if the region of the supposed object is concealed, for example by another traffic participant (truck) or a structure (tree). Due to the concealment, the object was not able to be recognized by the object recognition device because it was not visible. It is thereby also possible to prevent falsification of the confidence value, since some objects may often be concealed on a road with heavy traffic flow, and these would therefore have an excessively low confidence value. In other words, the confidence value is not changed or adjusted if concealment of the supposed object has been recognized.

In some embodiments, the backend may also incorporate further parameters into the change in the confidence value of the objects, such as for example the temporal profile. In other words, if for example an object was present in the last 10 transmitted items of data and is not present in the digital road map in the backend, this may be a new object that should be added to the digital road map. The same may be true for an object that should be removed from the digital road map; for example, if an object has not been recognized in the last 10 transmitted items of data without there being concealment, the object may be removed from the digital road map because it is probably no longer present in reality, even though the confidence value may still be high. In other words, the most up-to-date recognition or lack of recognition of the object may have a greater influence on the confidence value than older recognitions. As an alternative or in addition, the confidence values may decrease over time if they are not confirmed by new recognitions.

The term “digital road maps” or “digital maps” should also be understood as meaning road maps for advanced driver assistance systems (ADASs), without navigation taking place. In particular, these digital road maps may be stored and created in a backend. In this case, an object may be for example a traffic sign, a guardrail, a road marking, traffic lights, a traffic circle, a crosswalk or a speed bump.

The transceiver unit may transmit the data to the backend wirelessly, over the air. The data may be wirelessly transmitted and/or wirelessly received by Bluetooth, WLAN (for example WLAN 802.11a/b/g/n/ac or WLAN 802.11p), ZigBee or WiMax or by means of cellular radio systems such as GPRS, UMTS, LTE or 5G. It is also possible to use other transmission protocols. The cited protocols provide the advantage of the standardization that has already taken place.

Backend may be understood as meaning a computing unit that is located outside one's own vehicle and is available for a multiplicity of vehicles or object recognition devices. The backend may be for example a server or a cloud, which is able to be reached via the Internet or another network.

In some embodiments, some steps may be performed by the object recognition device for the vehicle and some steps may be performed in the backend. The distribution between the evaluation by the evaluation unit of the object recognition device and the backend may furthermore be adjusted to the respective application case. In some embodiments, entire evaluation may also be performed in the backend. In this case, the object recognition device of the vehicle serves as data capture unit for the backend. The evaluation may however also be performed on the object recognition devices, and the result is then transmitted or conveyed to the backend, where the data from the individual vehicles are merged, thereby creating the digital road map with corresponding confidence values for each object in the digital road map, for example traffic signs.

In some embodiments, the data transmitted by the transceiver unit are vector data. In order to keep the amount of data transmitted between the object recognition device and the backend small or low, the data may be transmitted in the form of vector data, that is to say the information about the existence of an object and its position may be transmitted, and not all of the image data.

In some embodiments, the evaluation unit is configured to determine the probability of the correct recognition of the objects or the concealments of the objects on the basis of the distance and the angle of the recognized objects with respect to the object recognition device in the respective segment, wherein a greater distance between the respective segment and the object recognition device results in a lower probability of correct recognition and a shorter distance between the respective segment and the object recognition device results in a higher probability of correct recognition.

The probability of correct recognition can therefore depend on the relative position of the segment with respect to the object recognition device. The greater the distance and the further the object is in an edge region of the capture unit, the lower the probability of correct recognition of the object or the concealment may be. In a similar manner, the probability of correct recognition can be higher, the more central and/or closer an object or a concealment is with respect to the object recognition device.

In some embodiments, the backend incorporates the object or the concealment of the object for the determination of the confidence value only when the probability of correct recognition is above a predetermined threshold value. In other words, a low probability of correct recognition may result in it not being possible to make a precise statement on the object or the concealment in this segment, and therefore objects or concealments recognized by the evaluation unit with a low probability of correct recognition can remain unconsidered in the confidence value of the respective object. The threshold value for the probability, from which the recognized objects or concealments are taken into account in the confidence value, may be for example 30, 40 or 50%; all recognized objects with a probability below this threshold value are not used to determine the confidence value in the digital road map in the backend.

For example, the system may recognize an object, which could be a traffic sign on account of the geometry, in a remote segment, for example at a distance of 80 m from the object recognition device. The object recognition device can memorize the distance and therefore actually the position of the object. However, the object per se was not able to be accurately recognized on account of the distance and therefore the probability of the correct recognition of this object may be low (if there was a speed restriction to 60 or 80 or even no speed restriction). With the further approach and therefore possible more precise object recognition with a higher probability of correct recognition, the object is concealed on account of the viewing angle or a traffic participant.

The evaluation unit of the object recognition device would therefore recognize concealment of the object since the probability of correct recognition is below the predefined threshold value, and the confidence value of the object in the backend would not be adjusted. In other words, adjustment of the confidence value can be omitted if the object, its position or its content has not been recognized with a probability of correct recognition above a threshold value. Furthermore, it should be noted that, at a great distance or in a segment with a lower probability of correct recognition, it is possible to carry out rough recognition with a low value for the probability of correct recognition and, as soon as further or more precise recognition of the object can be carried out at a shorter distance or in a segment with a higher probability of correct recognition, the object, the position or the content of the object can be determined with a higher probability of correct recognition. This recognition with a higher probability of correct recognition can then be accordingly used in the backend to adjust the confidence value of the recognized object or concealment.

In some embodiments, the evaluation unit is configured to evaluate the surroundings data of a section of a route covered by the vehicle. The transceiver unit is configured to transmit the data relating to the entire section to the backend. In other words, the object recognition device in the vehicle may first collect and evaluate the data for a particular section and then transmit the entire section or the result for the entire section to the backend.

In some embodiments, in the case of the evaluation in sections, the section may also be referred to as a snippet, and the recognition (visibility) or the concealment (invisibility) may be expanded by a second probability factor for correct recognition. This increases when the object has been recognized in as many individual images (frames) of the respective section as possible or it is concealed. In other words, the second probability value depends on the relative frequency of the recognition of the object or the concealment. Thus, not only discrete values such as 0 (concealment) and 1 (recognition) may occur for the recognition or concealment, but also any values in between. The respective sections may furthermore also be defined with a certain overlap with respect to one another, such that a plurality of images (frames) are also present for the start of the respective section and the start does not consist of just one image. As an alternative or in addition, the recognitions in the sections may be normalized such that the number of recognitions is divided by the number of total images present that were able to recognize the respective object.

By virtue of transmitting the data to the backend in sections, the evaluation of recognizable and concealed regions may also be performed completely in the backend. In other words, the vehicle or the object recognition device in the vehicle serves as data capture unit and the data processing or the evaluation takes place in the backend. This means that a highly accurate position is not required for every object, but rather only for the beginning of the section. The rest of the position determination may be implemented using the image data in the backend, wherein the backend typically has a higher computational power than the evaluation unit. By virtue of the transmission in sections, highly accurate position information needs to be transmitted to the backend only for the beginning and the end of the respective section, and the backend may then calculate, determine or ascertain the respective positions, the objects and the concealments from the received data.

In some embodiments, the section is 100 m long. It should be noted that any other desired length may also be selected for the section, such as for example 200 m, 500 m, or 1 km. The section may furthermore be adjusted depending on the road or the surroundings, such that the section is shorter in urban surroundings than in rural surroundings or on an expressway. This may be advantageous since there are typically more objects over an identical section length in urban surroundings. The section may furthermore also be defined on the basis of a fixed file size, for example 5 MB, 25 MB or 1 GB, but the section or the length of the section may also be defined on the basis of a combination of the abovementioned criteria.

In some embodiments, the evaluation unit is configured to initially classify all captured segments in front of the vehicle in the respective section as concealed regions and, if an object has been recognized in a segment or a concealment is not recognized in the segment, to classify the corresponding segment as a visible region and to determine the probability of correct recognition. The backend is configured not to incorporate the concealed segments into the determination of the confidence values of the individual objects in the digital road map.

The evaluation unit may evaluate the captured data in sections, that is to say for each section or snippet, and transmit them to the backend. When evaluating the section, it is also possible to proceed in such a way that all regions are initially classified as concealed regions, that is to say regions in which it is not possible to make a statement about any objects. These concealed regions are then gradually classified as recognized regions (recognized objects or recognized concealments, including their probability of correct recognition) by means of the evaluation by the evaluation unit. In other words, the recognized region gradually becomes larger the more objects have been recognized therein. The regions that are not recognized remain classified as concealed regions and a confidence value of an object that may possibly be located in this region is not adjusted, since a reliable statement is not possible due to the concealment or the lack of recognition in this region.

In some embodiments, the object recognition device furthermore has a storage unit. A digital road map is stored with a multiplicity of objects in the storage unit. The evaluation unit is configured to compare the recognized objects with the objects stored in the storage unit. The evaluation unit is also configured to report recognized objects that are not present in the digital road map in the storage unit, or unrecognized objects that should be recognized according to the digital road map, to the backend.

The object recognition device may furthermore have a storage unit in which a digital road map is stored. The digital road map on the memory card may furthermore be updated at regular intervals by the backend, such that the up-to-date version of the digital road map is always available for the evaluation unit of the object recognition device. The evaluation unit may furthermore compare the recognized objects with the objects in the digital road map in the storage unit. The evaluation unit may then report recognized or unrecognized objects directly to the backend.

For example, if an object is present in the digital road map but was not recognized by the evaluation unit, the confidence value of the object can be reduced in the backend on the basis of the determined probability of correct recognition. If an object was recognized by the evaluation unit and is present in the digital road map, the confidence value of the object can be increased in the backend on the basis of the determined probability of correct recognition. If an object was recognized by the evaluation unit and is not contained in the digital road map, the recognized object may be added to the digital road map in the backend. Furthermore, in the case of the evaluation of the captured data in sections, the data may be buffer-stored in the storage unit until they are transmitted to the backend.

In some embodiments, the positioning unit is a GPS module. Furthermore, it should be pointed out that, within the context of the present invention, GPS is representative of all global navigation satellite systems (GNSSs), such as for example GPS, Galileo, GLONASS (Russia), Compass (China) or IRNSS (India). At this juncture, it should be pointed out that the position of the vehicle may also be determined by means of cell positioning. This is particularly beneficial when using GSM, UMTS, LTE or 5G networks.

In some embodiments, the surroundings data are camera images, camera images from a stereo camera, laser images, lidar images or ultrasound recordings.

In some embodiments, the digital road map is intended for a vehicle or for the navigation of a vehicle. The digital road map created in the backend may be intended for a vehicle in order to enable navigation for said vehicle. A precise and up-to-date digital road map is essential, in particular in the case of highly or fully automated vehicles.

In some embodiments, the backend is configured to transmit the digital road map to the storage unit of the object recognition device at periodic time intervals. In other words, the backend may transmit the digital road map that is generated, updated, changed and/or improved there to the object recognition device of the vehicle or vehicles again at certain intervals, such that the evaluation unit of the object recognition device in turn has the up-to-date version of the digital road map available again. These periodic intervals may be for example once a month, every day or once a year. The backend may furthermore also transmit the digital road map to the vehicle as required, for example when navigation has been started on the vehicle.

In some embodiments, the backend is configured to transmit only objects having a confidence value above a predefined threshold value to the storage unit of the object recognition device. In other words, objects may be incorporated into the digital road map and transmitted to the object recognition device if the confidence value of the objects in the digital road map on the backend exceeds a predefined threshold value, for example have a confidence value of over 90%. This may be used to ensure that only objects that are very likely to be present are transmitted to the vehicle.

In some embodiments, the backend is configured to evaluate the received data and to remove unrecognized objects from or to integrate new objects in the digital road map in the backend on the basis of the received data. In other words, the backend may change and update the digital road map based on the data received from the transceiver unit of the object recognition device and, if necessary, add new objects or remove old objects, such that there is always an up-to-date digital road map on the backend that represents the current road conditions. The backend may furthermore update the exact position of the individual objects in the digital road map based on the received data, for example since the position is able to be determined more precisely on average by the individual object recognition devices due to an increasing number of recognitions of the respective object.

In some embodiments, there is a vehicle having an object recognition device. The object recognition device has a capture unit, an evaluation unit, a positioning unit and a transceiver unit. The capture unit is configured to capture surroundings data from a vehicle and to divide the surroundings data into a plurality of two-dimensional or three-dimensional segments. The positioning unit is configured to determine the positions of the segments and of the objects contained therein. The evaluation unit is configured to recognize the objects and concealments of the objects in the segments and to provide them with position information. The evaluation unit is also configured to determine a probability of correct recognition for each of the objects and for each concealment, wherein the probability depends on the relative position of the segment, in which the object or the concealment is located, with respect to the vehicle. The transceiver unit is configured to transmit the data generated by the evaluation unit to a backend.

The vehicle is for example a motor vehicle, such as an automobile, a bus or a truck, or else a rail vehicle, a ship, an aircraft, such as a helicopter or an airplane, or for example a bicycle.

In some embodiments, there is a backend containing a digital road map and confidence values for the objects therein. The backend is configured to receive the data from a transceiver unit and to generate, to change or to update the digital road map. Furthermore, each of the objects in the digital road map in the backend has a confidence value. The backend is configured to increase the confidence value of the respective object on the basis of the determined probability if the respective object is included in the received data, and to reduce the confidence value of the respective object on the basis of the determined probability if the respective object is not included in the received data, wherein the backend is configured to not reduce the confidence value of the respective object if the object is concealed in the received data.

In other words, the backend may receive data from an object recognition device of a vehicle. The objects or concealments included in the data can be used by the backend to change the confidence values of the objects in the digital road map on the basis of the determined probabilities of correct recognition. It should be noted that the object recognition device may in this case perform an evaluation before the data are sent to the backend or else the object recognition device sends all of the data captured by the capture unit to the backend and the data are evaluated (for the most part) in the backend. In other words, the capture unit may capture surroundings data relating to a vehicle, and these may then be evaluated by the evaluation unit of the object recognition device or by the backend. The data may in this case be transmitted continuously or in sections from the object recognition device to the backend.

The data from the object recognition device may contain a plurality of different objects or concealments of objects, wherein the objects may each have a probability of correct recognition depending on the relative position of their respective segment with respect to the object recognition device. On the basis of these objects or concealments of objects and their probabilities of correct recognition, the backend can change the confidence values of the objects contained in the digital road map on the backend.

In this case, a confidence value of an object in the digital road, for example, can be increased on the basis of the determined probability of correct recognition if the object is included in the data from the object recognition device. A new object may furthermore be added to the digital road map if an object is included in the data from the object recognition device, but no object has been present up to now at this position in the digital road map. It is thus possible to add new objects to the digital road map on the backend, and the digital road map is always able to be kept up-to-date. Furthermore, the backend can decrease or reduce the confidence value of an object on the basis of the determined probability of correct recognition if an object included in the digital road map has not been recognized by the object recognition device. This reduction in the confidence value may not be performed if the object recognition device recognizes a concealment in the region of the object. In other words, if the capture unit of the object recognition device did not have the possibility of recognizing an object since the latter was concealed, the confidence value for this object is not adjusted since no definitive statement can be made.

The backend may furthermore remove an object from the digital road map if the confidence value of this object falls below a predefined threshold value, for example 60% or 70%, or if the object has not been recently recognized by a predefined number of vehicles, for example 10. “Old” objects that in reality are no longer present may therefore be removed from the digital road map.

During the evaluation of the data by the evaluation unit of the object recognition device, the object recognition device can directly report an unrecognized object with the corresponding probability of correct recognition, that is to say an object which should have been recognized but has not been recognized, to the backend. To this end, however, a digital road map is required as a comparison in the object recognition device; this may be stored on a storage unit, for example. Newly recognized objects, that is to say that were not present until now in the digital road map in the object recognition device, may also be reported to the backend.

In some embodiments, it is possible to adjust or change not only the confidence values of the objects, that is to say whether or not an object is present, but also its exact position, that is to say where the object is located and the content thereof, in particular in the case of changing and dynamic display panels. The more object recognition devices recognize an object and determine its position, the more accurately the “correct” position of the real object is able to be determined. Furthermore, a probability density function for the correct position may also be determined around the respective object.

It should be noted that the backend may simultaneously receive and process data from a multiplicity of object recognition devices of different vehicles. The respective object recognition devices of the vehicles may thus be used as sensors in order to keep the digital road map on the backend up-to-date, to update it or to change it and to add new objects or to delete old objects. The up-to-date digital road map may furthermore be transmitted to the object recognition devices of the vehicles again by the backend, such that they always have the up-to-date digital road map available.

In some embodiments, there is a method for generating confidence values for objects in a digital road map. The method comprises the following steps:
capturing surroundings data and dividing said data into a plurality of two-dimensional or three-dimensional segments by means of a capture unit;
determining the position of the segments and the objects contained therein;
evaluating the captured surroundings data in each of the segments;
recognizing objects and concealments of objects in each of the segments;
determining a probability of correct recognition for each object or each concealment, wherein the probability depends on the relative position of the segment, in which the object or the concealment is located, with respect to the vehicle;
providing the objects and the concealments of the objects with position information;
transmitting the generated data from a transceiver unit to a backend;
generating or updating the digital road map in the backend based on the received data;
increasing the confidence value of the respective object on the basis of the determined probability of correct recognition if the respective object is included in the received data;
reducing the confidence value of the respective object on the basis of the determined probability of correct recognition if the respective object is not included in the received data, wherein the respective object is not reduced in the event of a concealment of the object in the received data.

In some embodiments, the steps of the method may also be performed in a different order or at the same time. There may furthermore also be a longer period between individual steps.

In some embodiments, there are program elements that, when they are executed on an evaluation unit and a backend of an object confidence value generation system, prompt the evaluation unit and the backend to perform the method described above and below.

In some embodiments, there is a computer-readable medium on which a program element is stored that, when it is executed on an evaluation unit and a backend of an object confidence value generation system, prompts the evaluation unit and the backend to perform the method described above and below.

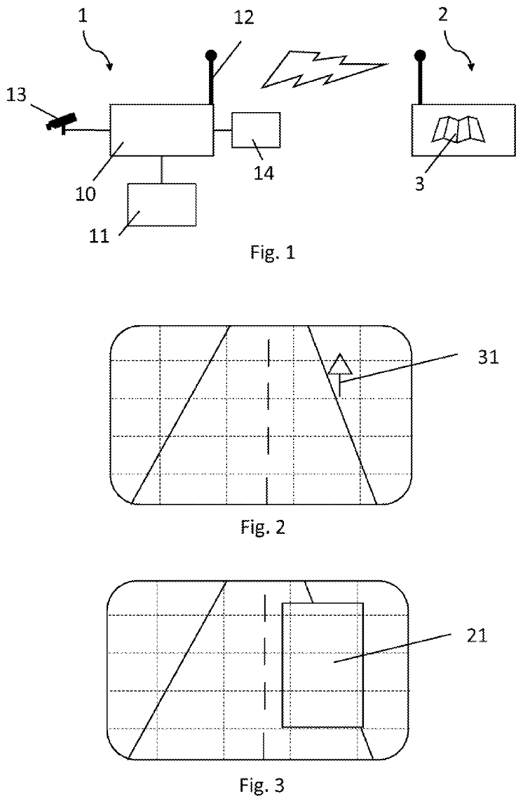

FIG. 1 shows a block diagram of an object confidence value generation system. The object confidence value generation system has an object recognition device 1 and a backend 2. The object recognition device 1 for its part has an evaluation unit 10, a positioning unit 11, a transceiver unit 12, a capture unit 13 and a storage unit 14. The object recognition device 1 and the backend 2 may exchange data with one another; this may take place for example wirelessly via mobile radio networks. A digital road map 3, which is updated, changed or generated with data from the object recognition device, may be present on the backend 2. The backend 2 may furthermore transmit data, such as the up-to-date digital road map 3, to the object recognition device 1. The transceiver unit 12 of the object recognition device 1 may be used in particular for the data exchange.

The capture unit 13 may be configured to capture surroundings data; in particular, the capture unit may capture surroundings data relating to a vehicle by way of different sensors. The capture unit 13 may be for example a camera, a stereo camera, a lidar sensor, a radar sensor, an ultrasonic sensor or a combination thereof. The capture unit 13 may capture temporally successive surroundings data, for example a video or a plurality of individual successive images (frames). Furthermore, the capture unit 13 can divide or split the surroundings data into a plurality of segments. The division can be effected, for example, on the basis of Cartesian coordinates (cuboids or cubes), cylindrical coordinates (sectors of a cylinder or circle) or spherical coordinates (spherical sectors).

The positioning unit 11 may be configured to determine the position of the object recognition device 1 and of objects and concealments captured by the capture unit 13. For example, the positioning unit 11 may be a GPS sensor. The storage unit 14 may contain a digital road map and the storage unit may furthermore be used as a buffer store if a transmission to the backend takes place in sections.

The evaluation unit 10 of the object recognition device 1 may be configured to recognize objects or concealments in the captured surroundings data and to provide them with a position. In this case, an object may be for example a traffic sign, a guardrail, a road marking, traffic lights, a traffic circle, a crosswalk or a speed bump. The evaluation unit 10 may furthermore recognize a concealment, that is to say an installation, for example a truck or a tree, that conceals the object to be recognized, that is to say is located between the object to be recognized and the capture unit 13. It is thus not possible to recognize an object since the object was not first captured by the capture unit 13 at all.

Furthermore, the control unit 10 can determine a probability of correct recognition for the recognized objects or concealments. This probability can depend on the relative position of the respective segment with respect to the object recognition device or the vehicle. The evaluation unit 10 may furthermore be configured to compare the captured and recognized objects with the objects stored in the storage unit 14, such that the evaluation unit 10 is able to establish whether an object that is not present in the digital road map in the storage unit 14 has been recognized, or that an object should have been present according to the digital road map stored in the storage unit 14 but was not recognized by the evaluation unit 10.

The object recognition device 1 may report these recognized or unrecognized objects directly to the backend 2. In other words, the evaluation may be performed by the evaluation unit 10 and the result is sent to the backend 2 in order accordingly to adjust or to update the digital road map 3 there. It should be noted that the evaluation can also be carried out in the backend 2; for this purpose, the object recognition device 1 sends all captured surroundings data, including the probability of recognition, from the capture unit 13 to the backend 2 and the backend 2 evaluates the data. It is thus possible to save on computational power on the object recognition device 1.

In some embodiments, the surroundings data may be evaluated in sections, that is to say in fixed sections of for example 100 m, wherein the individual sections may be referred to as snippets. The evaluation unit 10 may furthermore be configured to initially classify everything as concealed regions and, when objects or concealments have been recognized, to gradually classify them into captured regions, such that all regions that are not reliably recognized are considered to be concealments and no statement is able to be made there about the objects located there, and the confidence value of these objects is therefore not updated or adjusted in this case. This procedure may be particularly expedient in the case of the evaluation in sections, since an object is able to be captured over a certain period of time or over a certain distance through a plurality of different viewing angles and distances. In some embodiments, the individual sections or snippets may adjoin one another directly, but these may also each have an overlapping region such that information from a plurality of viewing angles and distances is already available even at the beginning of a respective section.

In some embodiments, repeated recognitions of an object in a section can also determine a second probability factor. For example, it may be possible to determine a factor for each object in a respective section, which factor reflects the number of correct recognitions of the object in a particular section. To this end, this factor may be for example between 0 and 1, wherein means that the object was captured and recognized by the evaluation unit 10 in all temporally consecutive surroundings data. In other words, the factor may be the number of recognitions of an object in the surroundings data for a section divided by the total amount of available surroundings data. By way of example, a section consists of 1000 individual images or frames and a particular object was recognized in 850 of these images, and the factor may thus be determined as 0.85.

In some embodiments, the factor may also be in the form of a number of recognitions of the respective object based on the number of possible recognitions. By way of example, the position of the object may be in the middle of a section, such that the object was able to be captured only through half of the available surroundings data; for example, the section consists of 1000 individual images but the object was only able to be present in 500 images or frames due to its position, and the object was recognized in 460 of these 500 images, and the factor may thus be determined as 0.92. In other words, the respective object is present in 92% of the surroundings data.

These evaluated data with the respective factors and the probability of correct recognition can be transmitted to the backend 2 and the backend 2 can in turn adjust, change or update the confidence value of the respective object in the digital road map 3 on the basis of these data. The data may be transmitted by the transceiver unit 12 to the backup 2 both continuously and in sections, in snippets.

FIG. 2 shows an exemplary image of the surroundings data. A road is illustrated in this case. At the edge of this road is a traffic sign that is recognized as an object 31 by the evaluation unit or by the backend. This image or the position of the recognized object 31 can be transmitted to the backend which in turn increases the confidence value of this object in the digital road map in the backend on the basis of the probability of correct recognition. Furthermore, FIG. 2 shows the division of the surroundings data into different segments which are represented by the dashed lines. The segments were generated here with the aid of Cartesian coordinates. The probability of correct recognition can depend on the respective position of the segment in which the object or the concealment is present. For example, the edge regions or segments which are for away can have a lower probability of correct recognition than central and nearby segments. This can be due, in particular, to optical effects in the capture unit and in the representation on the sensor (for example the camera); objects which are far away represented only by a few pixels, for example.

FIG. 3 likewise shows an exemplary image of the surroundings data, but in this case the object is concealed by a concealment 21. The evaluation unit or the backend is thus not able to recognize any object at this position. In other words, the concealment prevents the object from being recognized. The concealment may be caused for example by another traffic participant, such as a truck, or by a tree. If an object to be recognized is located behind a concealment, the confidence value of this object is not adjusted, since no statement is able to be made about the object. The division of the surroundings data into a plurality of segments by means of the dashed lines is also clear in FIG. 3.

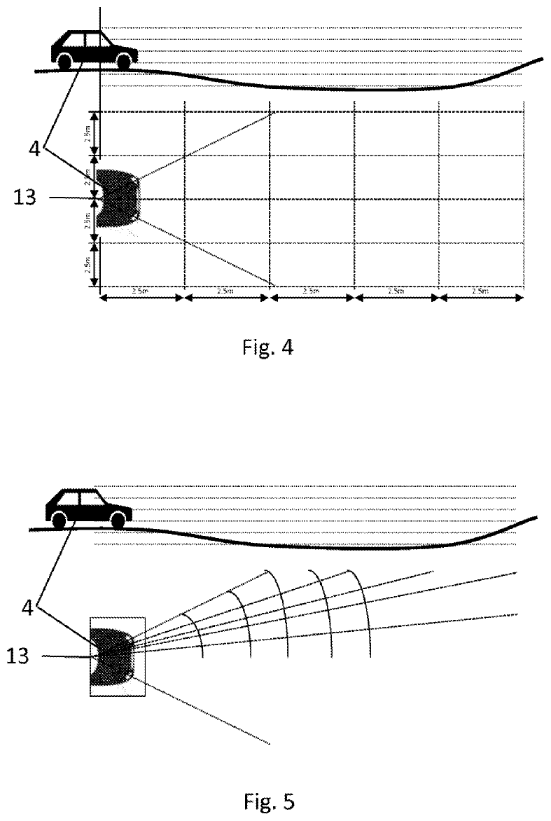

FIG. 4 shows the division or splitting of the surroundings data captured by the capture unit 13 into three-dimensional segments. In FIG. 4, the segments are divided or defined on the basis of Cartesian coordinates. The segments are therefore cuboids. A side view of a vehicle 4 and of a road is shown in the upper region of the figure. Furthermore, different dashed lines at different heights are illustrated and represent the division of the segments in terms of height. The individual lines are at a distance of approximately 50 cm from one another in this example. A plan view of the vehicle 4 is illustrated in the lower region of the image. Furthermore, a capture unit 13 (for example a camera) is located in the center of the vehicle 4. The field of view of the capture unit 13 is symbolized by the two obliquely running dashed lines. The opening angle or the field of view can vary depending on the capture unit 13 used. Furthermore, a plurality of rectangles in the field of view of the capture unit 13 are illustrated. These define the plurality of three-dimensional segments. In this case, the segments are cuboids having a width and a length of 2.5 m and a height of 0.5 m. It should be noted that other divisions are also possible, for example 1 m or 3 m. Furthermore, the height and the length may differ from one another.

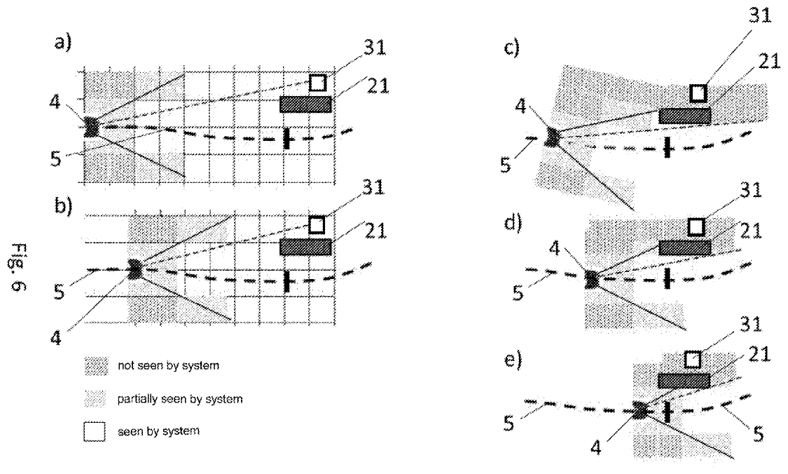

FIG. 5 shows, like FIG. 4, the division or splitting of the surroundings data into different segments, but the division is carried out on the basis of cylindrical coordinates in FIG. 5. The opening angle or the field of view of the capture unit 13 is sub-segmented on the basis of angles, for example 0.5°, in the lower region, and the length is defined on the basis of concentric circles which intersect the lines of sight at different locations. The definition of the height is the same as the method shown in FIG. 4.

FIG. 6 the progression of a vehicle 4 along a particular route over a certain time a) to e). This route is illustrated in FIG. 6 by the thick dashed black line. Furthermore, each of the parts a) to e) symbolizes an advanced time section. The route may in this case be divided into a plurality of sections 5 (snippets). The different sections 5 are shown in FIG. 6 by the thick vertical bars transverse to the direction of the route. The sections 5 may have a fixed distance, for example 100 m. The capture unit of the object recognition device of the vehicle 4 has a respective specific viewing angle. This is represented by the two solid thin lines starting from the vehicle 4.

Regions with different shading are illustrated to the left of, to the right of and in front of the vehicle 4 in FIG. 6 and symbolize the regions in the respective segments of the surroundings data relating to the vehicle 4 which were recognized by the object recognition device and which were not and the probability of correct recognition on the basis of the respective relative position of the segment with respect to the object recognition device. A dotted region symbolizes an unrecognized region and a white region symbolizes a region recognized by the object recognition device; the transition region is shown in gray. It should be noted that, the further along the vehicle 4 is on the route (a) to e)), the higher the probability that the region has been recognized, since the object recognition device has recorded a large number of individual images or frames in which the region was able to be recognized.

At the beginning of the route, the capture unit can recognize only the objects in front of the vehicle and can only partially recognize the objects to the side; the further along the route the vehicle moves, the more often the object recognition device has the opportunity to recognize an object 31 in the vehicle surroundings or the more often an object 31 or a concealment 21 has been recognized. Between an unrecognized region and a recognized region, the region may also have been partially recognized by the object recognition device or have been recognized only in a few items of image data or frames.

A vehicle 4 which moves along a route, an object 31 to be recognized and a concealment 21 are present in FIG. 6. In the first section a), the vehicle 4 can recognize the object 31 since the view is clear, but the probability of correct recognition is still low on account of the distance. For example, the visibility of the object 31 may be 100% and the probability of correct recognition may be 10%. In the second section b), the vehicle has already moved further on the route in the direction of the object 31. Furthermore, the object 31 is recognized and the probability of correct recognition is increased since the distance between the vehicle 4 and the object 31 becomes shorter. For example, the visibility of the object 31 may still be 100% and the probability of correct is 30%.

In section c), the vehicle 4 has advanced even further on the route, with the result that the object 31 is concealed by the concealment 21. The concealment 21 is between the object 31 and the vehicle 4. For example, the visibility of the object 31 is now 0% and the probability of correct recognition of the object 31 would be 75%. In section d), the vehicle 4 has advanced even further and the object 31 is still concealed, with the result that the visibility is still 0%, for example, but the probability of correct recognition increases to 95% on the basis of the distance or the segment relative to the vehicle. In section e), the concealment 21 still conceals the object 31, with the result that no object 31 can be recognized. For example, the visibility can be 0% here and the probability of correct recognition can be 100%.

In some embodiments, all of the regions may initially be classified as unrecognized regions and, as soon as a recognition takes place, this region may be classified as a recognized region. Furthermore, the confidence value of the recognized region can be increased with increasing recognitions in a plurality of images or frames.

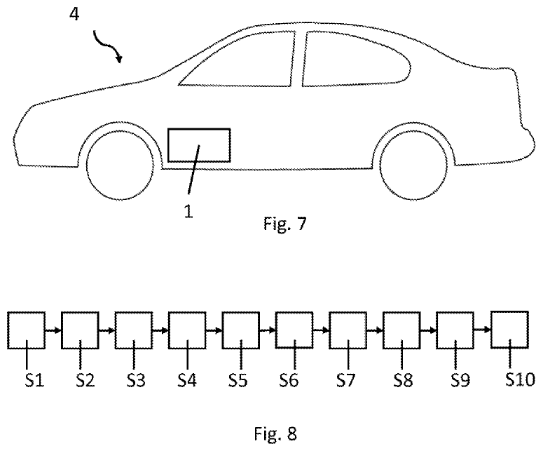

FIG. 7 shows a vehicle 4 having an object recognition device 1. This object recognition device 1 is able to capture surroundings data around the vehicle 4 and recognize objects and concealments therein. The object recognition device 1 may furthermore transmit the evaluated data to the backend. A multiplicity of vehicles 4 may furthermore use an object recognition device 1 to capture and evaluate surroundings data and transmit them to the backend.

FIG. 8 shows a flowchart for a method for generating confidence values for objects in a digital road map. In a first step S1, surroundings data can be captured by a capture unit and said data are divided into a plurality of two-dimensional or three-dimensional segments. These surroundings data may be individual images or frames or a whole section of successive images or frames. In a second step S2, the position of the captured surroundings data and of the objects contained therein may be determined. The captured surroundings data can be evaluated in segments in step S3, and objects and concealments can be recognized in the respective segments of the surroundings data in step S4.

In step S5, the probabilities of correct recognition can be determined for each of the recognized objects or concealments, wherein the probabilities depend on the relative position of the segment, in which the object or the concealment is located, with respect to the object recognition device or the vehicle. In step S6, the objects and concealments recognized in step S5 may be provided with position information. In step S7, the evaluated data may be transmitted to a backend by way of a transceiver unit. Then, in step S8, the digital road map may be generated, changed or updated on the backend based on the received data. In step S9, a confidence value of a respective object can be increased on the basis of the determined probability of correct recognition if the respective object is included in the received data. In step S10, a confidence value of an object can be reduced on the basis of the probability of correct recognition if the object is not included in the received data, except if the object was concealed by a concealment, with the result that it could not be recognized in the captured surroundings data.

What is claimed is:

1. An object confidence value generation system for a digital road map, the system comprising:
a backend; and
an object recognition device for a vehicle,
the object recognition device including:
a capture unit,
an evaluation unit,
a positioning unit, and
a transceiver unit;
wherein the capture unit is configured to capture surroundings data and to divide the surroundings data into a plurality of two-dimensional or three-dimensional segments;
the positioning unit is configured to determine respective positions of the segments and of any objects represented in the surroundings data;
the evaluation unit is configured to recognize the objects and concealed objects in the segments and to associate them with position information;
the evaluation unit is configured to determine a probability of correct recognition for each object and for each concealed object;
wherein the probability depends on the relative position of the segment in which the object or the concealed object is located, with respect to the object recognition device;
wherein the transceiver transmits the data generated by the evaluation unit to the backend;
wherein the backend generates or updates the digital road map based on the data from the transceiver;
wherein each of the objects in the digital road map has an associated confidence value;
wherein the backend increases the confidence value of the respective object on the basis of the determined probability if the respective object is included in the received data; and
wherein the backend reduces the confidence value of the respective object on the basis of the determined probability if the respective object is not included in the received data;
wherein the backend does not reduce the confidence value of the respective object in the event of the object is concealed in the received data.

2. The system as claimed in claim 1, wherein:
the evaluation unit is configured to determine a probability of the correct recognition of the objects or the concealed objects on the basis of a distance and an angle of the objects with respect to the object recognition device in the respective segment;
a greater distance between the respective segment and the object recognition device results in a lower probability of correct recognition; and
a shorter distance between the respective segment and the object recognition device results in a higher probability of correct recognition.

3. The system as claimed in claim 1, wherein the backend incorporates an object or a concealed object for the determination of the confidence value only when the probability of correct recognition is above a predetermined threshold value.

4. The system as claimed in claim 1, wherein:
the evaluation unit is configured to evaluate the surroundings data relating to a section of a route covered by the vehicle; and
the transceiver sends the data relating to the entire section to the backend.

5. The system as claimed in claim 4, wherein the section is 100 m long.

6. The system as claimed in claim 1, wherein:
the evaluation unit is configured to initially classify all captured segments in front of the vehicle in the respective section as concealed regions;
if an object has been recognized in a segment or a concealed object is not recognized in the segment, to classify the corresponding segment as a visible region and to determine the probability of correct recognition; and
the backend is configured not to incorporate the concealed segments into the determination of the confidence values of individual objects in the digital road map.

7. The system as claimed in claim 1, the object recognition device furthermore comprising a memory storing the a digital road map containing a multiplicity of objects;
wherein the evaluation unit is configured to compare the recognized objects with the objects stored in the map; and
the evaluation unit is furthermore configured to report recognized objects not present in the digital road map, or an absence objects that should be recognized according to the digital road map, to the backend.

8. The system as claimed in claim 1, wherein the backend is configured to transmit the digital road map to the storage unit of the object recognition device at periodic time intervals.

9. The system as claimed in claim 8, wherein the backend is configured to transmit only objects having an associated confidence value above a predefined threshold value to the storage unit of the object recognition device.

10. The system as claimed in claim 1, wherein the backend is configured to evaluate the received data and to remove unrecognized objects from or to integrate new objects in the digital road map on the basis of the received data.

11. A vehicle comprising:
an object recognition device having:
a capture unit,
an evaluation unit,
a positioning unit,
transceiver;
wherein the capture unit is configured to capture surroundings data and to divide the surroundings data into a plurality of two-dimensional or three-dimensional segments,
the positioning unit is configured to determine respective positions of the segments and of any objects contained the segments;
the evaluation unit is configured to recognize objects and concealed objects in the segments and to associate them with position information;
the evaluation unit is configured to determine a probability of correct recognition for each of the objects and for each concealed object;
the probability depends on the relative position of the segment, in which the object or the concealed object is located, with respect to the vehicle,
the transceiver unit transmit the data generated by the evaluation unit to a backend.

12. A backend storing a digital road map and confidence values for objects represented on the map, the backend comprising:
a receiver in communication with a transceiver unit;
a processor programmed to generate or to update the digital road map based on data received from the transceiver;
wherein each of the objects represented in the digital road map has an associated confidence value;
wherein the backend is configured to increase the confidence value of the respective object on the basis of the determined probability if the respective object is included in the received data; and
the backend is configured to reduce the confidence value of the respective object on the basis of the determined probability if the respective object is not included in the received data;
the backend is configured not to reduce the confidence value of the respective object in the event of the object is concealed in the received data.

13. A method for generating and maintaining a digital road map, the method comprising:
capturing surroundings data and dividing said data into a plurality of two-dimensional or three-dimensional segments with a capture unit;
determining a respective position for each of the segments and any objects contained in a segment;
evaluating the captured surroundings data in each of the segments;
recognizing objects and concealed objects in each of the segments;
determining a probability of correct recognition for each object or concealed object, wherein the probability depends on the relative position of the segment, in which the object or the concealment is located, with respect to the vehicle;
providing the objects and the concealed objects with position information;
transmitting the generated data to a backend;
generating or updating the digital road map in the backend based on the received data;
increasing a confidence value of the respective object on the basis of the determined probability of correct recognition if the respective object is included in the received data; and
reducing the confidence value of the respective object on the basis of the determined probability of correct recognition if the respective object is not included in the received data;
wherein the respective object is not reduced in the event of a concealed object in the received data.

14-15. (canceled)
